(19) United States
(12) Patent Application Publication
(10) Pub. No.: US 2009/0104556 A1
(43) Pub. Date: Apr. 23, 2009

(54) Polymeric Colour Electrophotographic Toner Compositions and Process of Preparing Polymeric Electrophotographic Toner Composition

(76) Inventors: William Grierson, Renfrewshire (GB); Lee Christina Miller, Ayrshire (GB); Kishor Kumar Mistry, West Yorkshire (GB); Bryan David Grey, West Yorkshire (GB); Mark Christopher Baxter, West Yorkshire (GB)

Correspondence Address: JoAnn Villamizar;Ciba Corporation/Patent Department, 540 White Plains Road, P.O. Box 2005, Tarrytown, NY, 10591, US

(21) Appl. No.: 12/084,342

(22) PCT Filed: Nov. 6, 2006
(86) PCT No.: PCT/EP2006/068094

§ 371 Date: Apr. 29, 2008

(30) Foreign Application Priority Data
Nov. 14, 2005 (EP) 05110720.9

(51) Int. Cl. G03G 9/09; G03G 9/08

(52) U.S. Cl. 430/108.23; 430/105; 430/110.4; 430/108.1; 430/108.2; 430/137.1

(57) ABSTRACT

The present invention relates to micron to sub-micron sized coloured polymeric electrophotographic toner particles, a process for making those particles and their use as dry or liquid electrophotographic toners, and as component in the preparation of two-component electrophotographic developers. The particles comprise two different kinds of polymers and are made through dewatering of a water-in-oil emulsion.

The present invention relates to micron to sub-micron sized coloured polymeric electrophotographic toner particles, a process for making those particles and their use as dry or liquid electrophotographic toners, and as component in the preparation of two-component electrophotographic developers.

The electrophotographic toner or the two-component electrophotographic developer is for example to be used for an image forming apparatus such as an electrostatic copying apparatus, a laser beam printer or the like.

The expressions “electrophotographic toner”, “toner particle” and “toner” are all used with equivalent meaning in the context of the present invention.

The coloured polymeric electrophotographic toner particles of the present invention are also useful as such in a powder coating process or for the preparation of powder coating compositions.

The essential components of an electrophotographic toner particle are a polymeric matrix and a colourant. Customary optional ingredients are charge control agents, waxes and/or UV absorbers. The polymeric matrix is the main component making up from about 40% to about 99% by weight of the particles. The polymeric matrix carries the colourant and fuses it to the substrate. It influences the toxicity, the fusing properties, the melt rheology and the triboelectric charging properties of the toner particle. Pigments are the colourants most widely used in electrophotographic toners. The four main colours used are black, yellow, cyan and magenta. However, there are now electrophotographic printers available which print using a wider range of additional colours such as green and orange for improved colour gamut. The pigment dispersion and concentration within the polymeric matrix affects the colour, the rheology and the triboelectric charging properties of the toner. Generally, significant improvements in controlling toner charge sign and charge level are obtained when incorporating charge control agents. Suitably, they are only present in small quantities, usually from 0.001% to 5%, preferably from 0.002% to 3% and most preferred from 0.005% to 1%, by weight, based on the weight of the toner particle. A toner particle is generally within the size range of 3 to 15 μm, preferably 3 to 11 μm, with a narrow particle size distribution (95% by weight of the particles within 5 μm of the mode).

A two-component electrophotographic developer essentially consists of a mixture of a few weight percent of toner with larger size carrier beads. The carrier beads serve two functions; they provide (1) a method for mechanically transporting the fine toner particles and (2) a means of charging the toner.

Most commercial electrophotographic toners currently manufactured are produced by a conventional melt-mixing method. In this process the pigment, the charge control agent and other active ingredients are mechanically dispersed in a molten polymer resin. This is followed by cooling the resulting dispersion before milling to the desired particle size, generally using a jet mill.

Toner produced by such grinding methods results in particles with irregular shapes and a wide particle size distribution, rendering it poorly suitable for high-resolution printing. Using mechanical grinding methods to further decrease the average particle size, however, results in a poor yield. This essential step of pulverisation using mills also requires a high input of energy and is therefore extremely costly. Alternative toner production methods which lead to well dispersed, regularly shaped, fine and mechanically stable particle toners are thus of great interest to toner manufacturers.

Particle size and size distribution are important parameters strongly influencing the quality of toners. Smaller particle sizes together with uniform size distribution make it possible to impart a much more even charge on the particles which become easier to control as they are transferred onto paper. Hence, the print's image quality is improved.

Encapsulated or chemical toner is toner that is manufactured by dispersing or emulsifying the raw materials such as pigment, optional charge control agent and other ingredients into a dispersing medium before using one of several different methods of particle formation. Using chemical methods such as micro-encapsulation is a highly efficient yet simple way of controlling toner particle size and size distribution. A number of different techniques have been used, but each of these has its disadvantages:

In Arshady, “Microspheres and Microcapsules: A Survey of Manufacturing Techniques. Part 1: Suspension Cross-Linking”, Polym. Eng. Sci. 29, 1746-1758 [1989], there are disclosed suspension cross-linking methods based on the formation of small droplets of a polymer solution or melt in an immiscible liquid followed by hardening of these droplets by covalent cross-linking resulting in hardened discrete polymeric particles. In the case of capsules for electrophotographic toners, the presence of certain desirable colourants and/or optional charge control agents causes problems with the cross-linking reaction leading to insufficient curing and poor control of parameters such as glass transition temperature (T_{g}) and fusing temperature, both of which are critical to the performance of the product. This restricts the choice of ingredients and bars the way to significant improvements.

U.S. Pat. No. 4,330,460, U.S. Pat. No. 4,727,011, U.S. Pat. No. 4,868,086 and U.S. Pat. No. 5,324,616, for example, disclose a suspension polymerisation method for encapsulation of a pigment. In this process, the pigment and other ingredients such as charge control agents and waxes are dispersed into the monomer. Then small monomer droplets of controlled size are formed as oil-in-water suspension/emulsion by stirring the monomer into an aqueous phase in the presence of a suspending agent. Addition of a polymerisation initiator or application of heat leads to the formation of polymeric particles in the aqueous phase with encapsulated pigment and other ingredients. However, the presence of a pigment and optional charge control agent or wax interferes with the polymerisation initialisation, so that the curing is often incomplete or inhomogeneous. In addition, it is necessary to disperse the pigment and any other solid ingredient or additive into the monomer. Incorporation of these components is often problematic because dispersants also influence the polymerisation.

U.S. Pat. No. 4,725,522, U.S. Pat. No. 4,761,358 and U.S. Pat. No. 5,529,877 disclose the manufacture of toners by interfacial polymerisation to form microcapsules containing a solid polymer/colourant core surrounded by a polymer shell. As in the case of suspension polymerisation, the presence of certain pigments and other additives slows the polymerisation or even prevents it. Additionally, this process as well requires the dispersion of the colourant into the monomer with the difficulties mentioned above.

U.S. Pat. No. 5,358,821 describes a process wherein a presscake of polymer encapsulated pigment is mixed with a molten thermoplastic binder. The pigment flushes into the binder which is then cooled and has to be pulverised as with conventionally produced toners. Such pulverisation processes often result in particles with irregular shapes and a wide particle size distribution.

Furthermore, since all the encapsulation methods listed above rely on the formation of oil-in-water suspensions/emulsions, they result in large amounts of effluent wastewater requiring costly wastewater treatment. This problem becomes especially relevant, when pigments derived from or treated with a soluble dyestuff are employed as toner colourant, since such pigments tend to bleed into the aqueous phase and the coloured wastewater has to be especially dealt with.

There are a number of references relating to encapsulation techniques which start from aqueous dispersions or presscakes of pigments. In U.S. Pat. No. 6,894,090 for example, there is described a process wherein an aqueous dispersion of colourant is mixed with an aqueous resin dispersion. This mixture is then coagulated by acidification or salting out to form the toner particles. WO 03/087949, U.S. Pat. No. 5,863,696 and U.S. Pat. No. 6,472,117 also disclose similar processes. Another closely related process is presented in U.S. Pat. No. 5,604,076, U.S. Pat. No. 5,650,255, U.S. Pat. No. 5,698,223 and U.S. Pat. No. 5,723,252. There, the coagulation is caused by the electrostatic interaction of an anionic surfactant used to stabilise the aqueous latex and a cationic surfactant used to stabilise the aqueous pigment dispersion. The resulting aggregate suspension is then heated above the T_{g} of the polymer leading to the final particles. However, the need to salt out the dispersions or to coagulate with oppositely charged surfactants requires that dispersions have to be formulated to optimise the toner formation process rather than the key toner properties such as colour strength, which depend largely on the individual dispersions of resin, pigment and optional charge control agent.

WO 02/090445 discloses polymeric particles comprising a polymeric matrix and a colourant distributed throughout it. The polymeric matrix is formed from a blend of monomers comprising an ethylenically unsaturated ionic monomer and an ethylenically unsaturated hydrophobic monomer. Typical polymeric matrices include copolymers that have been formed from styrene with ammonium acrylate. The polymeric particles exhibit very good retention properties and are able to retain the colourant under a variety of conditions. However, these particles tend to suffer the drawback that they fracture or even shatter under harsh conditions, thus leading to release of the colourant, making them unsuitable for use as electrophotographic toner.

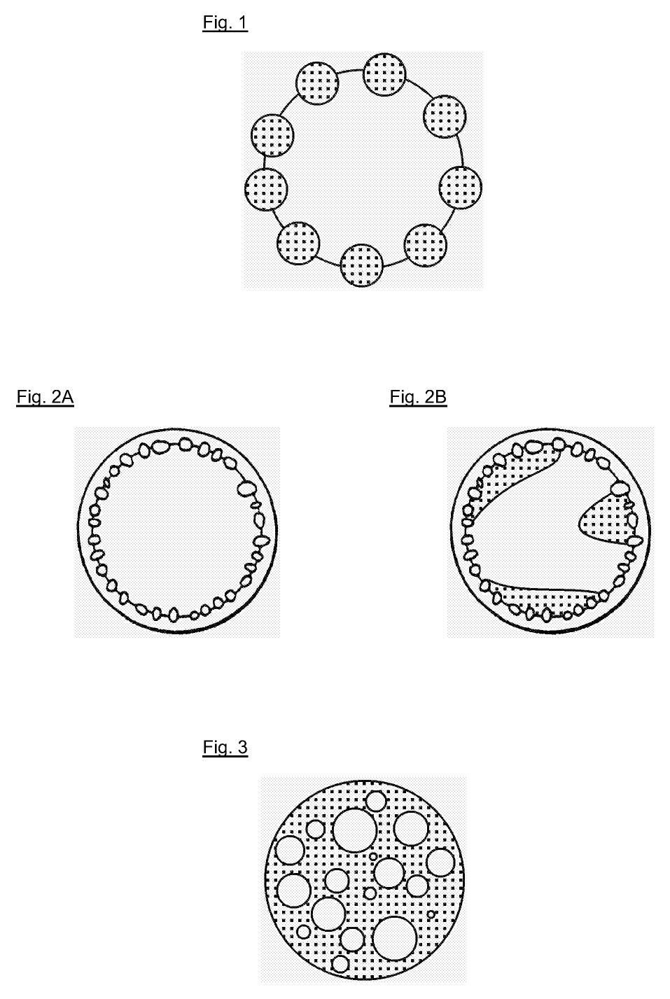

EP 0362859A2 discloses toner particles consisting of uniformly coloured main particles covered by protuberances (pimples) consisting of harder latex particles having a higher hydrophility than the polymer of the main particles. The structure of such toner is represented in FIG. 1. However, the hard pimples do not hinder shattering, while the toner's properties, especially the chargeability, are undesirably modified. Moreover, this process is very complicated and difficult to control as it involves the separate manufacture of the two components and additional steps in which the latex is first partially fused into the main particles to form pimples, and then loose latex particles still remaining at the surface must be removed in order not to impair the charge properties (see example 4). Furthermore, this process leads to a lot of wastewater.

WO 87/01828A1 discloses a composite toner, made by mechanical impact, which comprises a coloured or non-coloured core with functional particles on its surface, the whole being embedded in a shell-forming resin. The structure of such toner is represented in instant FIG. 2a. Optionally, a polar polymer may be employed which gathers at the surface of the inner particles, thus forming a pseudocapsule structure as represented in FIG. 2b. The functional particles can be charge-controlling (both suppressing or enhancing), coloured, abrasive or releasing particles, such as metal alloys, metal oxides, nitrides, carbides, sulfates and carbonates, semiconductors, ceramics, dyes, pigments, charge controllers, waxes and fatty acid metal salts. However, the properties of such toner particles, especially the shatter resistance, are still not fully satisfactory. The colourant is dispersed either in the particles affixed outside the core, thus leading to unsatisfactory dispersion, transparency and colour strength, or in the hydrophobic, soft binder, thus impeding full polymerisation and leading to bleeding. These disadvantages are especially important in the case of toners comprising organic colourants to be used in full colour systems.

WO 05/123 009 and WO 05/123 796 (both prior art pursuant to Art. 54(3) and (4) EPC and Rule 64.3 PCT) disclose in Example 5 coloured polymeric particles comprising 20.4% by weight of colourant. It is therefore desirable to have an electrophotographic toner with coloured polymeric electrophotographic toner particles that retain the colourant and optionally further ingredients and that are resistant to shattering, comprising colourants and optional further ingredients optimally selected based on criteria of best possible performance of the resulting toner and not based on their processability during the process of manufacture. Furthermore, it is desirable for such toner to be obtainable by a simple, efficient and environmentally friendly process. Moreover, organic pigments and dyes should be excellently dispersed so as to achieve high transparency, colour strength and/or chroma.

One objective of the present invention is to provide micron to sub-micron sized coloured polymeric electrophotographic toner particles that are shatter resistant and that retain the encapsulated colourant and optionally further ingredients under a variety of operating conditions when used in electrophotographic toners.

It is another objective of the present invention to provide a simple and universal process for the fabrication of said particles that allows improved freedom in selection of colourants and optional further ingredients. In that process, the colourants and optional further ingredients do not hinder the polymerisation process in the formation of the polymeric matrix.

A further objective of the present invention is to provide a process for the fabrication of an electrophotographic toner without having to disperse the colourants and optional further ingredients in a monomer.

It is yet another objective of the present invention to provide an ecological and economical process for the fabrication of an electrophotographic toner by avoiding large amounts of effluent wastewater, especially by avoiding coloured wastewater.

In addition, it is also an objective of the present invention to provide a method for converting pigments and oil or water soluble dyes into a micron to sub-micron sized coloured polymeric particle that can be used as such in a powder coating process, or as a colourant for the preparation of powder coating compositions.

It has now surprisingly been found that these and other objectives of the present invention are accomplished by providing specific micron to sub-micron sized shatter resistant coloured polymeric particles and a specific process for their manufacture.

Thus according to the present invention there are provided coloured polymeric electrophotographic toner particles comprising
a polymeric matrix consisting of a copolymer (I) comprising reoccurring units derived from at least two monomers (a) and (b), wherein monomer (a) is an ethylenically unsaturated ionic or potentially ionic monomer and monomer (b) is an ethylenically unsaturated hydrophobic monomer, which polymeric matrix is crosslinked or not crosslinked;
secondary particles of a hydrophobic polymer (II) distributed throughout said polymeric matrix, which hydrophobic polymer (II) comprises reoccurring units derived from an ethylenically unsaturated hydrophobic monomer (c) and optionally other monomers (d), and which hydrophobic polymer (II) is different from the copolymer (I) of the polymeric matrix;
a colourant, preferably in an amount from 0.1% to 20% by weight, based on the weight of the coloured polymeric electrophotographic toner particles; and
optionally a charge control agent.

FIG. 1 shows a toner particle according to EP 0 362 859 A2 (prior art discussed above). The spotted areas are the protuberances (pimples) consisting of harder, hydrophilic latex particles.

FIG. 2a shows a toner particle according to FIG. 8 of WO 87/01828A1 (prior art discussed above), consisting of a coloured or non-coloured core with functional particles on its surface, the whole being embedded in a shell-forming resin.

FIG. 2b shows a variant thereof, wherein the inner core is a pseudocapsule consisting of a binder and a polar polymer (spotted areas) gathering at the binder's surface, as disclosed on page 17 of WO 87/01828A1.

FIG. 3 shows an instant toner, in which particles of the hydrophobic polymer (II) are distributed throughout a matrix consisting of a copolymer (I) comprising ionic or potentially ionic groups (shown as spotted areas). The particles of the hydrophobic polymer (II) are not represented at scale, as compared with the size of the matrix.

All figures represent cuts through the center of the corresponding particles.

Optionally, the coloured polymeric electrophotographic toner particles may comprise further ingredients or a mixture of further ingredients.

In a further aspect of the present invention, there is provided a process for preparing coloured polymeric electrophotographic toner particles comprising
a polymeric matrix consisting of a copolymer (I) comprising reoccurring units derived from at least two monomers (a) and (b), wherein monomer (a) is an ethylenically unsaturated ionic or potentially ionic monomer and monomer (b) is an ethylenically unsaturated hydrophobic monomer,
which polymeric matrix is crosslinked or not crosslinked;
secondary particles of a hydrophobic polymer (II) distributed throughout said polymeric matrix, which hydrophobic polymer (II) comprises reoccurring units derived from an ethylenically unsaturated hydrophobic monomer (c) and optionally other monomers (d), and which hydrophobic polymer (II) is different from the copolymer (I) of the polymeric matrix;
a colourant, preferably in an amount from 0.1% to 20% by weight, based on the weight of the coloured polymeric electrophotographic toner particles; and
optionally a charge control agent and/or further ingredients or a mixture of further ingredients,
   (A) which process comprises the steps of providing an aqueous phase comprising said copolymer (I), preferably in the form of a salt thereof;
   (B) forming the secondary particles in said aqueous phase or preforming the secondary particles outside said aqueous phase and combining them with said aqueous phase;
   (C) dissolving or dispersing the colourant and the optional charge control agent and/or further ingredients in the aqueous phase at any stage before, during or after steps (A) or (B);
   (D) forming a water-in-oil emulsion consisting essentially of the aqueous phase from steps (A), (B), and (C), thus comprising the copolymer (I), the secondary particles, the colourant and the optional charge control agent and/or further ingredients, in a water immiscible liquid phase which preferably comprises an amphipathic polymeric stabiliser;
   (E) removing water from said emulsion thereby forming an oil dispersion comprising solid coloured polymeric electrophotographic toner particles, the polymeric matrix of which comprises the secondary particles, the colourant and the optional charge control agent and/or further ingredients distributed throughout it; and
   (F) optionally isolating, washing and/or drying said coloured polymeric electrophotographic toner particles.

Surprisingly, the coloured polymeric electrophotographic toner particles of the instant invention exhibit improved shatter resistance in combination with improved visual performance and furthermore the polymeric matrix does not allow any of the entrapped ingredients such as colourant and optionally further ingredients to be released even under prolonged use.

Furthermore, the instant toners also have excellent general properties, such as appropriate fusing temperature and release properties, enhanced powder flow and handling characteristics, even, stable and consistant charging properties, high colour strength, good adhesion to the required range of substrates, superior storage stability, and the like.

The term “(co)polymer comprising reoccurring units derived from (a) monomer(s)” means that the starting monomer(s) is (are) reacted into, and thus is (are) part of, the finished polymer or copolymer. The reoccurring units may be arranged statistically, in blocks, grafted, isotactically or syndiotactically.

The coloured polymeric electrophotographic toner particles according to the first aspect of the present invention and the products resulting from the process according to the second aspect of the present invention have enhanced shatter resistance.

The coloured polymeric electrophotographic toner particles of the present invention comprise a polymeric matrix consisting of a copolymer (I) comprising reoccurring units derived from at least two monomers (a) and (b).

Monomer (a) is an ethylenically unsaturated ionic or potentially ionic monomer. The term “ionic monomer” is to be understood as a monomer having a proton ionizable group, thus being neutral or ionic depending on the pH, or a monomer having a permanent ionic charge independent of the pH. Thus, an anionic monomer may be neutral or anionic depending on the pH. Generally, an anionic monomer is anionic at a pH of 7. A cationic monomer may be neutral or cationic depending on the pH. Generally, a cationic monomer is cationic at a pH of 7. The term “potentially ionic monomer” is to be understood as a monomer being readily convertible into an ionic monomer in situ prior to or during the polymerisation process. Acid anhydrides are typical examples of such potentially ionic monomers, since they are readily hydrolysed into ionic monomers in situ. One or more anionic or potentially anionic monomers or one or more cationic or potentially cationic monomers may be used as the ethylenically unsaturated ionic or potentially ionic monomer (a).

The monomer (a) may have either anionic or potentially anionic or cationic or potentially cationic groups. Preferably, the monomer (a) is an ethylenically unsaturated anionic or potentially anionic monomer. Examples of such monomers include, but are not limited to, ethylenically unsaturated carboxylic acids, acid anhydrides, sulphonic acids and phosphonic acids. Preferred ethylenically unsaturated anionic or potentially anionic monomers include (meth)acrylic acid, ethacrylic acid, fumaric acid, maleic acid, maleic anhydride, itaconic acid, itaconic acid anhydride, crotonic acid, vinyl acetic acid, (meth)allyl sulphonic acid, styrene sulphonic acid, vinyl sulphonic acid and 2-acrylamido-2-methyl propane sulphonic acid. Most preferably, the ethylenically unsaturated anionic or potentially anionic monomers are carboxylic acids or acid anhydrides.

In an alternative embodiment of the present invention, the monomer (a) may be an ethylenically unsaturated cationic or potentially cationic monomer, for instance an ethylenically unsaturated amine such as, but not exclusively, dialkylamino-alkyl-(meth)acrylate, dialkylamino-alkyl-(meth)acrylamide, vinyl amine, allyl amine and other ethylenically unsaturated amines and their acid addition salts. Typically, the dialkylamino-alkyl-(meth)acrylates include dimethylamino-methyl acrylate, dimethylamino-methyl methacrylate, dimethylamino-ethyl acrylate, dimethylamino-ethyl methacrylate, diethylamino-ethyl acrylate, diethylamino-ethyl methacrylate, dimethylamino-propyl acrylate, dimethylamino-propyl methacrylate, diethylamino-propyl acrylate, diethylamino-propyl methacrylate, dimethylamino-butyl acrylate, dimethylamino-butyl methacrylate, diethylamino-butyl acrylate and diethylamino-butyl methacrylate. Typically, the dialkylamino-alkyl (meth)acrylamides include dimethylamino-methyl acrylamide, dimethylamino-methyl methacrylamide, dimethylamino-ethyl acrylamide, dimethylamino-ethyl methacrylamide, diethylamino-ethyl acrylamide, diethylamino-ethyl methacrylamide, dimethylamino-propyl acrylamide, dimethylamino-propyl methacrylamide, diethylamino-propyl acrylamide, diethylamino-propyl methacrylamide, dimethylamino-butyl acrylamide, dimethylamino-butyl methacrylate, diethylamino-butyl acrylate and diethylamino-butyl methacrylamide. Typically, the allyl amines include diallyl amine and triallyl amine.

Monomer (a) may be wholly or partially in the form of the free acid or wholly or partially in the form of the free base. Preferably, however, monomer (a) is a salt of a counterion, which counterion is the conjugated acid of a volatile base or the conjugated base of a volatile acid.

When the monomer (a) is anionic or potentially anionic, for instance a carboxylic acid or an acid anhydride, the counterion preferably is ammonium or the conjugated acid of a volatile amine component, for instance ethanolamine, methanolamine, 1-propanolamine, 2-propanolamine or dimethanolamine. Generally, the volatile amine component will be a liquid that can be evaporated at low to moderate temperatures, for instance at temperatures up to 200° C. at normal pressure. Preferably, it will be possible to evaporate the volatile amine under reduced pressure at temperatures below 100° C. Thus the copolymer (I) of the polymeric matrix may be prepared by copolymerising the ammonium salt of an ethylenically unsaturated anionic or potentially anionic monomer or the salt of the conjugated acid of a volatile amine of an ethylenically unsaturated anionic or potentially anionic monomer with the ethylenically unsaturated hydrophobic monomer (b), resulting in the copolymer (I) being a polymeric salt of the conjugated acid of a volatile amine. Alternatively, the copolymer (I) may be produced by copolymerising the ethylenically unsaturated anionic or potentially anionic monomer in its free acid form with the ethylenically unsaturated hydrophobic monomer (b), followed by neutralisation with an aqueous solution of ammonium hydroxide or a volatile amine (e.g. ethanolamine, methanolamine, 1-propanolamine, 2-propanol-amine or dimethanolamine), resulting in the copolymer (I) being a polymeric salt of the conjugated acid of a volatile base.

When the monomer (a) is cationic or potentially cationic, the counterion is preferably the conjugated base of a volatile acid (e.g. acetic acid, formic acid, propanoic acid, butanoic acid or carbonic acid). Generally, the volatile acid will be a liquid that can be evaporated at low to moderate temperatures, for instance at temperatures up to 200° C. at normal pressure. Preferably, it will be possible to evaporate the volatile acid under reduced pressure at temperatures below 100° C. Thus, in this embodiment of the invention, the copolymer (I) is generally formed in an analogous way as mentioned above for the case of using an ethylenically unsaturated anionic or potentially anionic monomer, except that the ethylenically unsaturated anionic or potentially anionic monomer is replaced by an ethylenically unsaturated cationic or potentially cationic monomer. Generally, where the copolymer (I) is prepared in the form of a copolymer of an ethylenically unsaturated free amine monomer and an ethylenically unsaturated hydrophobic monomer (b), it is neutralised by including a suitable volatile acid, for instance acetic acid, formic acid, propanoic acid, butanoic acid or even carbonic acid. Preferably, the co-polymer (I) is neutralised by a volatile carboxylic acid, resulting in the copolymer (I) being a polymeric salt of the conjugated base of a volatile acid.

The ethylenically unsaturated hydrophobic monomer (b) is suitably a monomer with a solubility in water of less than 10 g per 100 ml of water, preferably of less than 5 g per 100 ml of water. One or more ethylenically unsaturated hydrophobic monomers may be used as the ethylenically unsaturated hydrophobic monomer (b). Suitable monomers (b) include, but are not limited to, alkyl (meth)acrylates, aryl (meth)acrylates, N-alkyl (meth)acrylamides, alkyl vinylcarbonates, alkyl vinylcarbamates, silicone-containing (meth)acrylates, silicone-containing (meth)acrylamides, silicone-containing vinyl carbonates, silicone-containing vinyl carbamates, styrenic monomers, acrylonitriles and polyoxypropylene (meth)acrylates. Preferred monomers (b) are alkyl (meth)acrylates, aryl (meth)acrylates and styrenic monomers. Specific examples of said monomers (b) include styrene, methyl methacrylate, tertiary butyl methacrylate, phenyl methacrylate, cyclohexyl methacrylate and isobornyl methacrylate.

The term “(meth)acryl” is used to designate both acryl and methacryl compounds.

Surprisingly, it is preferable to form the copolymer (I) of the polymeric matrix using as monomer (b) monomers that are capable of forming a homopolymer of glass transition temperature (T_{g}) in excess of 50° C., preferably greater than 60° C. and most preferred greater than 80° C. The thus obtainable copolymers (I) exhibit considerably improved performance in regards of the impermeability towards the colourant and optional other ingredients.

Glass transition temperatures of homopolymers comprising reoccurring units derived from various monomers are well-known in the art and for example listed in the Polymer Handbook, J. Brandrup, E. H. Immergut, third edition, pages VI 209-277, John Wiley&Sons, New York, Chichester, Brisbane, Toronto, Singapore, 1989.

To use as monomers (b) ethylenically unsaturated carboxylic acid esters that are not capable of forming a homopolymer having a glass transition temperature of at least 50° C. would adversely increase the permeability of the polymeric matrix for the colourant and the optional further ingredients. For instance, using as monomer (b) certain (meth)acrylic esters, for instance ethyl acrylate, propyl acrylate or 2-ethylhexyl acrylate, would result in a polymeric matrix that fulfils only less stringent conditions regarding the impermeability towards the colourant and optional other ingredients.

The glass transition temperature for a polymer is defined in the Kirk-Othmer Encyclopedia of Chemical Technology, Volume 19, fourth edition, page 891 as the temperature below which (1) the transitional motion of entire molecules and (2) the coiling and uncoiling of 40 to 50 carbon atom segments of chains are both frozen. Thus, below its T_{g}, a polymer does not exhibit flow or rubber elasticity. The T_{g} of a polymer may be determined using Differential Scanning Calorimetry (DSC). Thus, a reference sample with known T_{g} and the experimental sample are heated separately but in parallel according to a linear temperature program. The two heaters maintain the two samples at identical temperatures. The power supplied to the two heaters to achieve this is monitored and the difference between them plotted as a function of reference temperature which translates as a recording of the specific heat as a function of temperature. As the reference temperature is increased or decreased and the experimental sample approaches a transition, the amount of heat required to maintain the temperature is be greater or lesser, depending on whether the transition is endothermic or exothermic.

The polymeric matrix may be cross-linked or not cross-linked. Preferably, however, the polymeric matrix is not cross-linked.

If cross-linking is performed, it may be achieved by including self cross-linking groups in the copolymer (I), for instance units derived from monomers carrying a hydroxymethyl (methylol) functionality. Alternatively, the cross-linking is achieved by including a cross-linking agent in the copolymer (I). The cross-linking agents are generally compounds which react with functional groups on the polymer chain. For instance, when the polymer chain contains anionic or potentially anionic groups, suitable cross-linking agents may be aziridines, diepoxides, carbodiamides, silanes or multivalent metals, such as aluminium, zinc or zirconium. Particularly preferred cross-linking agents are ammonium zirconium carbonate or zinc oxide. Another particularly preferred class of cross-linking agents includes compounds which form covalent bonds between polymer chains, for instance silanes or diepoxides.

If cross-linking of the polymeric matrix is performed, it preferably occurs during the step of removing water in the process of preparing the coloured polymeric particles as described infra. Thus, where a cross-linking agent is included, it will generally remain dormant until the removal of water is started.

Typically, the copolymer (I) is made from at least 50% by weight of ethylenically unsaturated hydrophobic monomer (b), up to 50% by weight of ethylenically unsaturated ionic or potentially ionic monomer (a) and up to 20%, preferably up to 10%, most preferred up to 5% by weight of optionally other monomers, based on the total weight of all monomers used to make the copolymer (I). Suitable as optional other monomers are monomers which are different from the ethylenically unsaturated ionic or potentially ionic monomer (a) and the ethylenically unsaturated hydrophobic monomer (b), such as non-ionic hydrophilic monomers, for example acrylamide. One or more anionic or potentially anionic monomers or one or more cationic or potentially cationic monomers may be used as the ethylenically unsaturated ionic or potentially ionic monomer (a). It may also be possible to use a blend of cationic or potentially cationic and anionic or potentially anionic monomers. One or more ethylenically unsaturated hydrophobic monomers may be used as the ethylenically unsaturated hydrophobic monomer (b). Generally, the ethylenically unsaturated hydrophobic monomer (b) are present in amounts of at least 60% by weight. Preferred monomer compositions for preparing the copolymer (I) comprise from 65% to 90%, preferably from 70% to 75% by weight of ethylenically unsaturated hydrophobic polymer (b), from 10% to 35%, preferably from 25% to 30% by weight, based on the total weight of all monomers used to make the copolymer (I), of ethylenically unsaturated ionic or potentially ionic monomer (a), and the remainder being made up of optional other monomers.

A particularly preferred copolymer (I) of the polymeric matrix is a copolymer of styrene and ammonium acrylate.

Generally, the copolymer (I) may be prepared by any suitable polymerisation process. For instance, the copolymer (I) can be conveniently prepared by aqueous emulsion polymerisation for instance as described in EP 0 697 423 or U.S. Pat. No. 5,070,136. The copolymer (I) can then be neutralised by the addition of an aqueous solution of ammonium hydroxide or a volatile amine in cases where the monomer (a) is anionic or potentially anionic, or by the addition of a volatile acid in cases where the monomer (a) is cationic or potentially cationic.

In a typical polymerisation process, a blend of ethylenically unsaturated ionic or potentially ionic monomer (a) and ethylenically unsaturated hydrophobic monomer (b) is emulsified into an aqueous phase which contains a suitable amount of emulsifying agent. Typically, the emulsifying agent may be any commercially available surfactant suitable for forming aqueous emulsions. Desirably, these surfactants tend to be more soluble in the aqueous phase than in the water immiscible monomer phase and thus tend to exhibit a high hydrophilic lipophilic balance (HLB). Typical surfactants useful in the present invention are of nonionic, cationic or anionic type. Many types of surfactants are known in the art and there is no particular restriction with respect to the surfactant used.

Nonionic surfactants are for example aliphatic or araliphatic compounds, such as ethoxylated phenols (mono, di, tri) with an ethoxylation degree of 3 to 50 and alkyl groups in the range from C₄-C₉, ethoxylated long chain alcohols, or polyethyleneoxide/polypropyleneoxide block copolymers.

Examples for anionic surfactants are alkali and ammonium salts of C₁₂-C₁₈alkyl sulfonic acids, dialkyl esters of succinic acid or sulfuric acid halfesters of ethoxylated alkanoles. These compounds are known for example from U.S. Pat. No. 4,269,749 and largely items of commerce, such as under the trade name Dowfax® 2A1 (Dow Chemical Company).

In general, anionic and non-ionic surfactants are preferred.

Furthermore, protective colloids such as polyvinylalcohols, carboxylated styrene copolymers, starch, cellulose derivatives or copolymers containing vinylpyrrolidone may be added to form conventional oil in water emulsions. Further examples are given in “Houben-Weyl, Methoden der Organischen Chemie, Band XIV/1, Makromolekulare Stoffe, G. Thieme Verlag Stuttgart 1961, 411-420”. Emulsification of the monomers may be effected by known emulsification techniques, including subjecting the monomers/aqueous phase to vigorous stirring, shearing or ultrasound, or alternatively passing the monomers/aqueous phase through a screen or mesh. Polymerisation may then be effected by use of suitable initiator systems, for instance UV initiators or thermal initiators. A suitable technique of initiating the polymerisation is for example to elevate the temperature of the aqueous emulsion of monomers to above 70° C. or 80° C. and then to add from 50 ppm to 1000 ppm by weight of ammonium persulphate, based on the weight of monomers (a) and (b), and optionally other monomers.

In a preferred polymerisation process, a blend of ethylenically unsaturated anionic or potentially anionic monomer (a) and ethylenically unsaturated hydrophobic monomer (b) is emulsified into an aqueous phase which contains a suitable amount of emulsifying agent and polymerisation is effected as described above.

In an alternative polymerisation process, a blend of ethylenically unsaturated cationic or potentially cationic monomer (a) and ethylenically unsaturated hydrophobic monomer (b) is emulsified into an aqueous phase which contains a suitable amount of emulsifying agent and polymerisation is effected as described above.

Generally, the copolymer (I) of the polymeric matrix has a molecular weight of up to 200,000 (weight average as determined by GPC). Preferably, the copolymer (I) has a molecular weight of below 50,000, for instance of from 2,000 to 20,000. Usually, the optimum molecular weight for the copolymer (I) is from 6,000 to 12,000.

In a preferred embodiment of the present invention, the copolymer (I) of the polymeric matrix has a glass transition temperature of from 30° C. to 10° C., preferably of from 50° C. to 80° C.

The coloured polymeric electrophotographic toner particles of the present invention also comprise secondary particles of a hydrophobic polymer (II) distributed throughout the polymeric matrix. The hydrophobic polymer (II) comprises reoccurring units derived from an ethylenically unsaturated hydrophobic monomer (c) and optionally other monomers (d). The hydrophobic polymer (II) of the secondary particles is different from the copolymer (I) of the polymeric matrix.

The monomer (c) of the secondary particles may be any of the monomers defined above in respect of the ethylenically unsaturated hydrophobic monomer (b) used to form the copolymer (I). Preferably, the monomer (c) of the secondary particles is the same as the monomer (b) used to form the copolymer (I). Preferred monomers (c) are alkyl (meth)acrylates, aryl (meth)acrylates and styrenic monomers. Specific examples of said monomers (c) include styrene, methyl methacrylate, tertiary butyl methacrylate, phenyl methacrylate, cyclohexyl methacrylate and isobornyl methacrylate. The most preferred monomer (c) is styrene.

Just as for (b), particularly suitable ethylenically unsaturated hydrophobic monomers (c) for the formation of the secondary particles are monomers capable of forming a homopolymer of glass transition temperature in excess of 50° C., preferably greater than 60° C. and most preferred greater than 80° C.

The monomer (c) may be polymerised alone or optionally may be copolymerised with one or more other monomers (d). The optional monomers (d) may be hydrophobic or not hydrophobic. If the monomer (d) is hydrophobic, it may be any of the monomers defined above in respect of the ethylenically unsaturated hydrophobic monomers (b) or (c). It is also possible to use hydrophobic monomers (d) that are not capable of forming a homopolymer of glass transition temperature in excess of 50° C., provided that such monomers do not bring about any deleterious effects. Suitable are for instance C₈-C₁₈alkyl esters of acrylic or methacrylic acid, such as 2-ethylhexyl acrylate or stearyl acrylate. Typically, where such monomers (d) are included, they should be present in an amount of not more than 20% by weight, based on the total weight of monomers (c) and (d) used to form the secondary particles. Preferably, these monomers (d) will be present in an amount of less than 10% by weight and more preferably of less than 5% by weight.

It is alternatively possible to include monomers (d) that are not hydrophobic monomers and that are not capable of forming a homopolymer of glass transition temperature in excess of 50° C., provided that such monomers do not bring about any deleterious effects. Alternatively, the optional monomers (d) may be hydrophilic monomers. The hydrophilic monomers may be non-ionic, for instance acrylamide, or ionic or potentially ionic, for instance as defined in respect of the ethylenically unsaturated ionic or potentially ionic monomer (a) used to form the copolymer (I). Generally, such monomers tend to be used in smaller proportions, so that the polymer of the secondary particles is hydrophobic. Typically, where such monomers (d) are included, they should be present in an amount of not more than 20% by weight, based on the total weight of monomers (c) and (d) used to form the secondary particles. Preferably, these monomers (d) are present in an amount of less than 10% by weight, more preferably less than 5% by weight.

Particularly preferred are secondary particles of a hydrophobic polymer (II) comprising reoccurring units derived from one or more ethylenically unsaturated hydrophobic monomer(s) which is/are capable of forming a homopolymer of glass transition temperature in excess of 50° C. Particularly suitable hydrophobic polymers (II) of the secondary particles are a copolymer of styrene and methyl (meth)acrylate and a homopolymer of styrene. The copolymer of styrene and methyl (meth)acrylate generally will comprise at least 40% by weight of styrene and up to 60% by weight of methyl (meth)acrylate. Preferably, the copolymer will have a weight ratio of styrene to methyl (meth)acrylate of from 50:50 to 95:5 and more preferably of from 60:40 to 80:20, particularly preferably of from 70:30 to 75:25.

Generally, the secondary particles have an average particle diameter below 1 μm, usually below 750 nm. Preferably, the secondary particles have an average particle diameter of from 50 nm to 500 nm, more preferred of from 100 nm to 300 nm. The particle size of the secondary particles can be determined for example by laser diffraction with a Malvern particle size analyser according to any of the procedures well documented in the literature.

Due to their much smaller size, as compared with the whole toner particle, there is suitably a plurality, suitably from 2 to about 10⁷ particles, of secondary particles of the hydrophobic polymer (II) distributed throughout the matrix of the copolymer (I).

The secondary particles may be prepared by any conventional means. Typically, the particles may be prepared by aqueous emulsion polymerisation. Preferably, the particles are prepared by aqueous microemulsion polymerisation according to any typical microemulsion polymerisation process documented in the prior art, for instance as described in EP-A-531 005 or EP-A-449-450.

Typically, the secondary particles may be prepared by forming an oil-in-water emulsion, preferably a microemulsion comprising water (from 20% to 80% by weight), the monomer (c) and optionally further monomers (d) (together from 10% to 70% by weight), and surfactant and/or stabiliser (from 10% to 70% by weight). Generally, the surfactant and/or stabiliser predominantly goes into the aqueous phase. A preferred surfactant and/or stabiliser is the polymeric salt of the copolymer (I) as described supra. A particularly preferred surfactant/stabiliser is a copolymer of ammonium acrylate and styrene, as defined above in relation to the copolymer (I) of the polymeric matrix.

Polymerisation of the monomer in the microemulsion can be effected by a suitable initiation system, for instance a UV initiator or a thermal initiator. A suitable technique of initiating the polymerisation is, for instance, to elevate the temperature of the aqueous emulsion of the monomer(s) to above 70° C., preferably above 80° C., and then to add from 50 ppm to 1000 ppm by weight of ammonium persulphate or an azo compound such as azodiisobutyronitrile, based on the weight of the monomer(s) (c) and optionally (d). Alternatively, a suitable peroxide, e.g. a room-temperature curing peroxide, or a photoinitiator may be used, and polymerisation may be carried out at about room temperature.

Generally, the secondary particles comprise a hydrophobic polymer that has a molecular weight of up to 2,000,000 (weight average as determined by GPC). Preferably, the hydrophobic polymer has a molecular weight below 500,000, for instance from 5,000 to 300,000. Usually, the optimum molecular weight for the hydrophobic polymer of the secondary particles is from 100,000 to 200,000.

Typically, the coloured polymeric electrophotographic toner particles comprise from to 80 parts by weight of copolymer (I) of the polymeric matrix and from 20 to 95 parts by weight of hydrophobic polymer (II) of the secondary particles. Preferably, they comprise from 10 to 65 parts by weight of copolymer (I) and from 35 to 90 parts by weight of hydrophobic polymer (II), most preferred from 20 to 40 parts by weight of copolymer (I) and from 60 to 80 parts by weight of hydrophobic polymer (11).

Without being limited by theory, it is believed that the particular combination of ionic or potentially ionic monomer (a), hydrophobic monomer (b) and secondary particles provides coloured polymeric electrophotographic toner particles with the right degree of hydrophilicity and hardness that seems to be responsible for the improvements in impermeability of the polymeric matrix to the colourant and the optional further ingredients as well as for the improved shatter resistance.

The coloured polymeric electrophotographic toner particles of the present invention comprise one or more colourants. Generally, the content of colourant is from 0.1 to 20% by weight, based on the weight of the coloured polymeric electrophotographic toner particles. Preferably, the content of colourant is from 0.5 to 18% by weight, more preferably from 1 to 15% by weight, and most preferred from 2 to 12% by weight, based on the weight of the coloured polymeric electrophotographic toner particles.

The colourant may be any type of colourant of any colour including black and white, for instance a dye or a pigment. Generally, the colourant is a pigment or a mixture of pigments selected from the group consisting of organic pigments and inorganic pigments, preferably the colourant is an organic pigment or a mixture of organic pigments.

The organic pigments may be those producing the four colours commonly used in the pigment-using industries, such as the coating, painting or printing industry: namely black, cyan (blue), magenta (red) and yellow. Pigments of other colours such as for example green and orange may also be used.

Organic pigments comprise for example, but not exclusively, monoazo, disazo, β-naphthol, naphthol AS, laked azo, benzimidazolone, azocondensation, metal complexes such as metal-complex azo, azomethine, isoindolinone, isoindoline, phthalocyanine, quinacridone, perylene, perinone, indigo, thioindigo, anthraquinone, indanthrone, anthrapyrimidine, flavanthrone, pyranthrone, anthanthrone, dioxazine, triarylcarbonium, quinophthalone, diketopyrrolopyrrole, nitro, quinoline, isoviolanthrone, pteridine and basic dye complex pigments. Mixtures of pigments may also be used. Preferred pigments are selected from the group consisting of monoazo, disazo, β-naphthol, naphthol AS, laked azo, azomethine, metal-complex azo, and phthalocyanine pigments, and mixtures of any thereof. For further details as to all those organic pigments, reference is made to Industrial Organic Pigments, W. Herbst, K. Hunger, 2^{nd} edition, VCH Verlagsgesellschaft, Weinheim, 1997.

Particularly suitable organic pigments are those listed in the Colour Index (C.I.) edited by the Society of Dyers and Colourists and the American Association of Textile Chemists and Colorists. Examples of such pigments are Pigment Yellow 1, 3, 12, 13, 14, 15, 17, 24, 62, 73, 74, 83, 93, 95, 108, 109, 110, 111, 120, 123, 128, 129, 139, 147, 150, 151, 154, 155, 168, 173, 174, 175, 180, 181, 185, 188, 191, 191:1, 191:2, 193, 194 and 199; Pigment Orange 5, 13, 16, 22, 31, 34, 40, 43, 48, 49, 51, 61, 64, 71, 73 and 81; Pigment Red 2, 4, 5, 23, 48, 48:1, 48:2, 48:3, 48:4, 52:2, 53:1, 57, 57:1, 88, 89, 112, 122, 144, 146, 149, 166, 168, 170, 177, 178, 179, 181, 184, 185, 190, 192, 194, 202, 204, 206, 207, 209, 214, 216, 220, 221, 222, 224, 226, 242, 248, 254, 255, 262, 264, 270 and 272; Pigment Brown 23, 25, 41 and 42; Pigment Violet 19, 23, 29, 31, 37 and 42; Pigment Blue 15, 15:1, 15:2, 15:3, 15:4, 15:6, 16, 25, 26, 60, 64 and 66; Pigment Green 7, 36 and 37; Pigment Black 31 and 32; as well as mixtures and solid solutions thereof.

Optionally, the organic pigments can be mixed with inorganic pigments which include among others titanium oxide pigments, iron oxide and hydroxide pigments, chromium oxide pigments, spinel type calcined pigments, lead chromate pigments, carbon black and Prussian Blue.

Alternatively, full replacement of organic pigments by inorganic pigments is also possible though not preferred.

Particularly suitable inorganic pigments are those listed in the Colour Index (C.I.) edited by the Society of Dyers and Colourists and the American Association of Textile Chemists and Colorists. Examples of such pigments are Pigment Yellow 34, 42, 53, 119, 164 and 184; Pigment Orange 20 and 21; Pigment Red 101 and 104; Pigment Brown 24, 33, 43 and 44; Pigment Blue 28 and 29; Pigment Green 17 and 50; Pigment White 6, 6:1 and 7; Pigment Black 6, 7, 8, 10, 12, 27 and 30; as well as mixtures thereof.

The coloured polymeric electrophotographic toner particles of the present invention preferably comprise a charge control agent. Mixtures of charge control agents are also suitable. The charge control agent may be either colourless or coloured.

A charge control agent is any additive incorporated into an electrophotographic toner with the role of influencing (enhancing, dictating, limiting or moderating) the specific sign and/or level of electrostatic charge achieved on the toner, modification of the rate to achieve this charge level or subsequent stabilisation of the charge once it is achieved. Any charge control agent generally used in the field of toners for use in electrophotography may be used for the purpose of the present invention. It is known in the art that certain colourants and derivatives thereof have charge control agent properties. Nevertheless, for the purpose of clarity within this invention, compounds having both a light absorption in the visible spectral range (400-700 nm) and charge control agent properties should be considered as whole or preferably part of the colourant as well as charge control agents. When the colourant or part of the colourant has charge control properties, it is preferred to use a colourant consisting of at least 2 components, thus enabling to tune the charge control properties. On the other hand, charge control agents lacking absorption in the visible spectral range should be considered as optional charge control agents.

Typical charge control agents (coloured or not coloured) include, but are not limited to:
amines, quaternary ammonium and pyridinium compounds or their metallised variants such as their molybdenum complexes, such as for example those disclosed in U.S. Pat. No. 3,893,935, U.S. Pat. No. 4,312,933 and U.S. Pat. No. 4,291,112;
metal complexed azo dyes, such as for example those disclosed in U.S. Pat. No. 4,433,040;
metal complexes and salts of organic compounds or mixtures of organic compounds including metal salicylates, such as for example those disclosed in U.S. Pat. No. 4,206,064, U.S. Pat. No. 4,404,271, U.S. Pat. No. 5,250,379, U.S. Pat. No. 5,250,381, U.S. Pat. No. 3,577,345, U.S. Pat. No. 4,404,271, U.S. Pat. No. 6,025,105, U.S. Pat. No. 4,762,763, U.S. Pat. No. 5,290,651, Japanese laid-open patent applications (JP-A) 2004-251 934, 2004-251 935, 2004-271 795 and 2004-271 796, WO 94 20437 and WO 94 23344;
azines, such as for example nigrosine;
azo and triphenylmethane dyes, such as for example those disclosed in EP 0 408 192;
solvent dyes and pigments, such as for example indanthrones, including metal complexes such as Solvent Red 102, such as for example those disclosed in U.S. Pat. No. 4,665,001 and U.S. Pat. No. 4,433,040;
modified or surface treated colourants, such as for example acidified or fluorinated carbon black;
phosphonium salts or organophosphates, such as for example those disclosed in U.S. Pat. No. 6,027,847 and Japanese laid-open patent applications (JP-A) Hei07-165 774, Hei06-130 727 and Hei05-119 508;
sulphones, such as for example those disclosed in U.S. Pat. No. 5,238,768;
borates, such as for example those disclosed in U.S. Pat. No. 4,767,688;
fumed silicas;
silanised alumina or titania;
halogenated organic acids or metal salts, such as for example those disclosed in U.S. Pat. No. 4,411,974 and U.S. Pat. No. 5,238,768;
organic ammonium sulphonate or carboxylate salts;
phenols, naphthols and carboxylated variants, such as for example those disclosed in EP 1 420 006, U.S. Pat. No. 5,290,651 and Acta Cryst. 2005, E61, pages 2587-2589;
metal free or metal complexed cyclic phenol oligomers such as the calixarenes, such as for example those disclosed in U.S. Pat. No. 5,318,883 and Japanese laid-open patent application (JP-A) 2003-186 252;
metal complexed diketones or ketoesters, such as for example those disclosed in U.S. Pat. No. 5,409,794;
metal complexed or metal free naphthoic acids, hydroxynaphthoic acids and/or their esters, such as for example those disclosed in EP 1 420 006, U.S. Pat. No. 5,451,482 and EP 1 462 440, U.S. Pat. No. 5,346,795 and EP 1 462 440;
pyrazolones, pyridones, pyrimidines, azopyridones, azopyrimidines, fluorenes, biphenylmethanes and carbazoles, such as for example those disclosed in CA 2 309 946, CA 2 309 823, WO 99 24874, WO 99 24872, WO 99 24871, U.S. Pat. No. 5,395,969, CA 1 337 296 and U.S. Pat. No. 5,278,315;
aromatic sulphonate salts of guanidine derivatives, such as for example those disclosed in WO 96 14294; and
polymeric charge control agents, such as polymer compounds having acidic groups, such as for example sulphonic acid, phosphonic acid or carboxylic acid groups, or polymer compounds having basic groups, such as for example primary amine, secondary amine, tertiary amine or quaternary amine groups; these polymeric charge control agents are meant to be additional compounds and of different structure than the previously mentioned (co)polymers (I) and (II).

Many representatives of the above mentioned types of charge control agents are commercially available. Examples include but are not limited to:
the BONTRON® range (Orient Chemical Ind Ltd): N-01, N-01A, N-02, N-03, N-04, N-07A, N-13, N-21, S-34, S-44, E-81, E-82, E-84, E-88, E-89, S-34, P-51 and P-53;
the Esprix® Technology materials: CCA-A4, P-12, N-22, N-23, N-24, N-24HD, N-25, N-28, N-29, N-30B, N-31, N-32A, N-32CA, N-32B, N-32CB and N-33;
Avecia Pro-Toner® CCA-7;
Hodogaya Chemical T-77, T-95, TRH, TN-105, TP-415, TP-525, TP-302 and Aizen Spilon Violet RH;
Clariant Copy Blue PR, Copy Charge PSY, Copy Charge N4P;
Wacker H DK® H2015EP, H2050EP, H2150VP, H3050VP, H1018, H1303VP, H2000/4, H2000, H3004, H15, H20, H30, H05TD, H13TD, H20TD, H30TD, H05TM, H13TM, H20TM, H30TM, H05TX, H13TX, H20TX, H30TX, H05TA, H13TA, H30TA;
the Japan-Carlit range such as LRA-901 and LR147;
the Hubei Dinglong range such as DL-N22D, DL-N24, DL-N23, DL-N28, DL-N33, DL-P12 and DL-N32CA.

The coloured polymeric electrophotographic toner particles of the present invention may optionally comprise further ingredients or a mixture of further ingredients. Generally, such further ingredients are selected from the group consisting of waxes and UV absorbers.

Electrophotographic toners may include waxes acting for example as releasing agents in order to improve the parting ability of the toner during fixing by a heating roll by preventing melted toner from sticking to the roll. Any wax generally used in the field of toners for use in electrophotography may be used for the purpose of the present invention. Examples of suitable waxes include, but are not limited to:
natural waxes such as vegetable-based waxes (e.g. candelilla wax, carnauba wax, Japan wax, rice wax, cotton wax, wood wax)
animal-based waxes (e.g. beeswax, lanoline, shellac wax) and mineral waxes (e.g. montan wax, ozokerite, ceresine) and petroleum-based waxes (e.g. paraffin wax, microcrystalline wax, petrolatum)
synthetic hydrocarbon waxes (e.g. Fischer-Tropsch wax, polyethylene wax, polypropylene wax, oxidised polyethylene wax)
synthetic waxes (e.g. aliphatic amide, ester, ketone, hydroxystearic acid, stearic acid amide, oleic acid amide, anhydrous phthalic acid imide, chlorinated hydrocarbon)
crystalline polymer resins with long alkyl side chains (e.g. homo- or co-polymers of acrylates such as n-stearyl methacrylate and n-lauryl methacrylate)
   as well as mixtures thereof.

The content of the wax is not specifically limited but is preferably not greater than 5% by weight, based on the weight of the polymeric electrophotographic toner particles.

The softening point of the wax is not specifically limited but is preferably from 50° C. to 180° C. in order to obtain the best performance.

The optional UV absorbers are incorporated for example to protect the colourant in the coloured polymeric electrophotographic toner particles from UV degradation by blocking ultraviolet radiation from reaching the colourant. Specific examples of suitable UV absorbers include, but are not limited to:
benzotriazole systems
benzophenone and its derivatives (e.g. 2-amino-2′,5-dichlorobenzophenone or 4,4′-bis(diethylamino) benzophenone or 5-chloro-2-hydroxy benzophenone or 2-amino-5-chlorobenzophenone),
acetophenone and its derivatives (e.g. 2-amino-4′,5′-dimethoxyacetophenone or 4′-piperazinoacetophenone or 4′-benzyloxy-2′-hydroxy-3′-methylacetophenone or 4′-piperidinoacetophenone or 2-bromo-2′,4-dimethoxyacetophenone or 2-bromo-2′,5′-dimethoxyacetophenone or 2-bromo-3′-nitroacetophenone or 3′,5′-diacetoxyacetophenone or 2-bromo-4′-nitroacetophenone or 2-phenylsulfonylacetophenone or 3′-aminoacetophenone or 4′-aminoacetophenone),
2-benzyl-2-(dimethylamino)-4′-morpholino butyrophenone
succinimide derivatives (e.g. 2-dodecyl-N-(1,2,2,6,6-pentamethyl-4-piperidinyl) succinimide or 2-dodecyl-N-(2,2,6,6-tetramethyl-4-piperidinyl) succinimide or N-(1-acetyl-2,2,6,6-tetramethyl-4-piperidinyl)-2-dodecyl succinimide)
1H-benzotriazole-1-acetonitrile
2-(2H-benzotriazol-2-yl)-4,6-di-tert-pentylphenol
1,1-(1,2-ethane-diyl)bis(3,3,5,5-tetramethylpiperazinone)
2,2,4-trimethyl-1,2-hydroquinoline
2-(4-benzoyl-3-hydroxy phenoxy)ethylacrylate,
(1,2,2,6,6-pentamethyl-4-piperidinyl/β,β,β′,β′-tetramethyl-3,9-(2,4,8,10-tetraoxo-spiro-(5,5)undecane)diethyl)-1,2,3,4-butane tetracarboxylate
2,2,6,6-tetramethyl-4-piperidinyl/β,β,β′,β′-tetramethyl-3,9-(2,4,8,10-tetraoxo spiro(5,5)-undecane) diethyl)-1,2,3,4-butane tetracarboxylate
(2,2,6,6-tetramethyl-4-piperidinyl)-1,2,3,4-butane tetracarboxylate
N-ρ-ethoxycarbonylphenyl)-N′-ethyl-N′-phenylformadine
6-ethoxy-1,2-dihydro-2,2,4-trimethylquinoline
2,4,6-tris-(N-1,4-dimethylpentyl-4-phenylenediamino)-1,3,5-triazine
nickel dibutyl dithio carbamate
metal oxides such as titanium oxide, zinc oxide, selenium oxide, and cerium oxide
   as well as mixtures thereof.

Generally, the average particle diameter of the coloured polymeric electrophotographic toner particles of the present invention is less than about 100 μm. Usually the average particle diameter tends to be smaller, for instance less than 80 μm or 70 μm, often less than 50 μm or 40 μm and typically the average particle diameter will be from 0.1 to 20 μm. Preferably the average particle diameter is from 0.8 to 9.9 μm and most preferred from 3 to 7 μm. The average particle diameter may be determined by a Coulter particle size analyser according to procedures well documented in the literature.

Generally the particle size distribution is such that an 80% weight fraction of the particles lie between 0.5 and 50 μm in size, preferably between 1 and 25 μm and most preferred between 1 and 15 μm.

It is preferred that the coloured polymeric electrophotographic toner particles have a fusing temperature of from 100 to 150° C., preferably from 120 to 150° C. The fusing temperature in an electrophotographic printing or copying process is the temperature required to fuse the polymeric particles (toner) to a medium, such as, for example, a paper sheet or an overhead projector transparency sheet. It may be determined by using a melting point apparatus as the temperature at which the polymeric particles begin to coalesce.

The process of the present invention avoids the above mentioned problems encountered in the prior art by starting from aqueous dispersions of polymer, colourant and further optional ingredients, each of which is optimised to give the best level of dispersion. There is no polymerisation and preferably no cross-linking required in the presence of certain interfering colourant(s) and/or charge control agents and the individual components can be dispersed to the optimum level before being used in the process.

The process of the present invention involves the formation of a water-in-oil emulsion consisting essentially of an aqueous phase in a water immiscible liquid phase. Said aqueous phase comprises the dissolved polymeric salt of the copolymer (I) or an emulsion of the copolymer (I), the secondary particles, the dissolved or dispersed colourant(s) and the optional further ingredients, such as for example charge control agents, waxes and UV absorbers.

Thus, the process of the present invention comprises the step of (A) providing an aqueous phase comprising a polymeric salt of the copolymer (I) of the polymeric matrix. The polymeric salt of copolymer (I) may be wholly or partly dissolved in the aqueous phase or may be present as an emulsion or suspension. Preferably, the polymeric salt of copolymer (I) is completely dissolved in the aqueous phase. By “completely dissolved,” as applied to the polymeric salt, is meant a polymeric salt which mixes spontaneously with water to form a homogeneous, thermodynamically stable, molecularly dispersed mixture.

The process of the present invention further comprises the step of (B) forming the secondary particles in the aqueous phase from step (A) or preforming the secondary particles outside said aqueous phase and combining them with the aqueous phase from step (A).

The secondary particles may be comprised within the aqueous phase of the polymeric salt of the copolymer (I) from step (A) as a result of polymerising the monomer(s) used to form the secondary particles by an aqueous emulsion or aqueous microemulsion polymerisation in an aqueous phase in the presence of said polymeric salt of the copolymer (I) as surfactant and/or stabiliser, for instance as described previously.

Alternatively, the secondary particles may be separately prepared and then dispersed within the aqueous phase from step (A) comprising the polymeric salt of the copolymer (I).

The process of the present invention further comprises the step of (C) dissolving or dispersing the colourant(s) and the optional charge control agent and/or further ingredients in the aqueous phase from steps (A) and/or (B).

The process of the present invention further comprises the step of (D) forming a water-in-oil emulsion consisting essentially of the aqueous phase from steps (A), (B) and (C), thus comprising the polymeric salt of copolymer (I), the secondary particles, the colourant and the optional charge control agent and/or further ingredients, in a water immiscible liquid phase which preferably comprises an amphipathic polymeric stabiliser

The colourant may be dissolved or dispersed in the aqueous phase at any stage of the process before forming the water-in-oil emulsion from step (D), for example during or after steps (A) or (B). However, it is preferred, that the colourant is dissolved or dispersed in the aqueous phase after the formation of the secondary particles from step (B), since the presence of certain colourant(s) interferes in the polymerisation process when forming the secondary particles. In the case of the colourant being a pigment, dispersion of the colourant in the aqueous phase may be achieved by any convenient means, for instance bead milling. The dispersion may include any dispersant or stabilising surfactant conventionally used for such aqueous dispersions. The pigment feedstock for the dispersion may be in any convenient form, for instance in dry powder, granule, or presscake form.

Coloured polymeric electrophotographic toner particles of the present invention that comprise optional charge control agent and/or further ingredients may for example be prepared by dissolving or dispersing the charge control agent and/or further ingredients in the aqueous phase at any stage of the process before forming the water-in-oil emulsion from step (D), for example during or after steps (A) or (B). Thus the water-in-oil emulsion from step (D) comprises the colourant(s), the charge control agent and/or further ingredients (e.g. UV absorbers and waxes) and the secondary particles distributed throughout the aqueous solution or emulsion of the copolymer (I) or salt thereof.

As an alternative, it is also possible to polymerise the monomer(s) used to form the secondary particles in an aqueous phase in the presence of the optional charge control agent and/or further ingredients or some of the optional further ingredients, resulting in all or some of the optional further ingredients becoming encapsulated in and distributed throughout the secondary particles. In particular, it is possible to polymerise the monomer(s) used to form the secondary particles in an aqueous phase in the presence of the UV absorbers, but preferably not in the presence of charge control agents and/or waxes. Optionally, the salt of the copolymer (I) is present as surfactant and/or stabiliser in the aqueous phase during that polymerisation.

Typically, the water immiscible liquid forming the oil phase of the emulsion of step (D) is an organic liquid or blend of organic liquids. The preferred organic liquid is a non-volatile paraffin oil having a boiling point above 200° C., typically in the range of from 210 to 300° C. at normal pressure. Optionally, a volatile paraffin oil having a boiling point in the range of from 100 to 175° C. at normal pressure may be mixed with the non-volatile paraffin oil. The two oils may be used in equal proportions by weight, but generally it is preferred to use the non-volatile oil in excess, for instance from more than 50 to up to 75% by weight of the non-volatile oil and from 25 to less than 50% by weight of the volatile oil.

In the process of obtaining the coloured polymeric electrophotographic toner particles according to the present invention, it is desirable to include a polymeric amphipathic stabiliser in the water immiscible liquid. The amphipathic stabiliser may be any suitable commercially available amphipathic stabiliser, for instance HYPERMER® (available from ICI). Suitable stabilisers also include the stabilisers described in WO-A-97/24179. Although it is possible to include other stabilising materials in addition to the amphipathic stabiliser, such as surfactants, it is generally preferred that the sole stabilising material is the amphipathic stabiliser. The process of the present invention further comprises the step of (E) removing water from the water-in-oil emulsion from step (D), thereby forming an oil dispersion comprising solid coloured polymeric electrophotographic toner particles, the polymeric matrix of which comprises the secondary particles, the colourant and the optional charge control agent and/or further ingredients distributed throughout it.

In the prior art cited above, the supporting liquid of the emulsion surrounding the polymeric particles is removed after formation of the polymeric particles. On the contrary, in the present invention it was surprisingly found that the dispersed phase, i.e. the water, can be removed from within the coloured polymeric electrophotographic toner particles without destroying their structure, while the supporting liquid surrounding the coloured polymeric electrophotographic toner particles remains in place.

In the process of the present invention, the removal of water in step (E) from the water-in-oil emulsion from step (D) can be achieved by any convenient means. Desirably, removal of water can be effected by subjecting the water-in-oil emulsion to distillation, preferably carried out under reduced pressure. Generally this will require elevated temperatures, for instance temperatures of from 10 to 90° C., preferably from 20 to 70° C. and more preferred from 30 to 60° C. Most preferably, the pressure is reduced accordingly, so as to obtain distillation temperatures below the glass transition temperature (T_{g}) of the copolymer (I).

Instead of vacuum distillation, it may be desirable to effect water removal by spray drying. Suitably, this can be achieved by the spray drying process described in WO-A-97/34945.

In a preferred embodiment, the water removal step (E) removes also the volatile acid or the volatile base originating from the counterion of the ethylenically unsaturated ionic or potentially ionic monomer (a) of the copolymer (I), which counterion is the conjugated acid of the volatile base or the conjugated base of the volatile acid as described supra. By this, we mean that at least a part, generally at least 10%, preferably at least 50% and most preferred at least 70% of the volatile acid or the volatile base is evaporated. For instance, where the copolymer (I) is the ammonium salt, the volatile base ammonia will be evaporated. Consequently, during the water removal step (E), the copolymer (I) is preferably converted to a polymeric matrix comprising reoccurring units that are at least partially in free acid or free base form. Additionally, the cross-linking of the polymeric matrix preferably occurs during the water removal step, if a cross-linking is performed. Thus, where a cross-linking agent is included, it generally remains dormant until the water removal is started. Preferably, however, no cross-linking agent is included.

The result of this process is an oil phase comprising dispersed solid coloured polymeric electrophotographic toner particles comprising the secondary particles, the colourant(s) and optionally charge control agents and/or further ingredients (e.g., UV absorbers and/or waxes) distributed throughout the polymeric matrix.

In an optional step (F), the coloured polymeric electrophotographic toner particles may be isolated, washed and/or dried. Preferably, isolation is achieved by filtration and drying occurs at ambient temperature. If desired, washing may be achieved with any suitable solvent, for example with petroleum ether. The separated water immiscible liquid may be recycled and reused in the process of the present invention.

The coloured polymeric electrophotographic toner particles of the present invention may be used as an electrophotographic toner as such and/or as a component for the preparation of a two-component electrophotographic developer. The isolated, washed and/or dried coloured polymeric electrophotographic toner particles may be used as a dry toner for electrophotography. Alternatively, the coloured polymeric electrophotographic toner particles dispersed in the water immiscible liquid may be used without prior isolation for the preparation of a liquid toner.

For the preparation of a two-component electrophotographic developer, the coloured polymeric electrophotographic toner particles of the present invention may be combined with larger size carrier particles and optionally further ingredients. Such carrier particles preferably have an average particle diameter of from 20 to 200 μm. The carrier used together with the toner is not particularly restricted, and known carriers are suitable, for example a resin-coated carrier or the like. Such a resin-coated carrier comprises a core material whose surface is coated with a resin, and as the core material, for example, powders having magnetic properties such as iron powder, ferrite powder, nickel powder and the like can be used. Various nonmagnetic particles such as glass beads, crystals of inorganic salts, hard resin particles and metal particles are also applicable. As the coating resin, for example, fluorine based resins, vinyl-based resins, silicone-based resins and the like are useful.

As well as being suitable as an electrophotographic toner and/or for the preparation of a two-component electrophotographic developer, the coloured polymeric electrophotographic toner particles according to the present invention are also suitable for other applications, for example for powder coatings. The particles can be used as such in a powder coating process or alternatively, for the preparation of powder coating compositions. When used for the preparation of powder coating compositions, it is preferred that the average size of the coloured polymeric electrophotographic toner particles is below 1 μm.

Powder coating is a known technology and is described, for example, in “Ullmann's Encyclopedia of Industrial Chemistry, Fifth, Completely Revised Edition, Volume A 18”, pages 438 to 444 (1991) in Section 3.4. In the powder coating process, a powder is generally fluidized with supply of air, electrostatically charged and applied to an earthed, preferably metallic substrate. The substrate is subsequently heated, in the course of which the adhering powder melts, coalesces and forms a coherent film on the metal surface. Since powder coating operates without solvent, this technology is especially friendly to the environment.

The definition of “powder coatings” is understood to be that as described in Ullmann's Encyclopedia of Industrial Chemistry, 5th, Completely Revised Edition, Vol. A 18, pages 438 to 444 (1991) in Section 3.4. Powder coatings are in particular thermoplastic or stovable, crosslinkable organic film-forming binders which are applied in powder form to predominantly metallic substrates. The manner in which the powder is brought into contact with the workpiece to be coated is, according to this invention, preferably electrostatic powder spraying. The powder particles applied, which adhere by means of Coulomb forces on the workpiece, are melted together in an oven and cured. The stoving temperatures used are usually from 140 to 260° C., in particular from 140 to 220° C., and depend mainly on the chemistry of the powder coating formulations and the oven design. The oven residence times are typically in the range from several minutes to ½ hour.

In the case of UV-curable systems, after application to the substrate, the powder coating composition according to this invention is first melted or heated, expediently using infrared radiation, to a temperature of from 50 to 180° C. Subsequently, the coating is cured with UV light, preferably while still hot.

When the coloured polymeric electrophotographic toner particles of the present invention are used as such in a powder coating process, they are applied to the substrate by electrostatic powder spraying.

Alternatively, the coloured polymeric electrophotographic toner particles of the present invention are used for the preparation of a powder coating composition. A powder coating composition comprising a colouristically active amount of the coloured polymeric electrophotographic toner particles is a further objective of the present invention. Generally, a powder coating composition according to the present invention comprises an organic film-forming binder, a colouristically active amount of the coloured polymeric electrophotographic toner particles, and optionally further additives.

A colouristically active amount of the coloured particles is generally from 0.01 to 70% by weight, preferably from 0.01 to 30% by weight, based on the weight of the powder coating composition.

Preferred powder coating compositions are those in which the organic film-forming binder is a polyester or polyacrylate resin together with a crosslinking agent, or an epoxy resin, or a combination of these resins.

Also of interest are film-forming binders with thermoplastic properties, examples being polyethylene, polypropylene, polyamides, polyvinyl chloride, polyvinylidene dichloride and polyvinylidene difluoride. Furthermore, powder coatings are also known which comprise ethylenically unsaturated components and can be cured with photoinitiators.

Preference is given to powder coating compositions in which the organic film-forming binder is an ethylenically unsaturated component which can be cured in the presence of a photoinitiator with light, especially ultraviolet light. Examples of appropriate light sources are medium-pressure or high-pressure mercury lamps.

The powder coating compositions according to this invention can in addition to the organic film-forming binder and the coloured polymeric electrophotographic toner particles optionally comprise conventional additives such as pigments, dyes, fillers, flow aids, degassing agents, optical brighteners, adhesion promoters, photoinitiators, anticorrosion agents, antioxidants, UV absorbers, light stabilizers and so forth.

In general, all of the components of the powder coating composition are weighed out and mixed together in an appropriate mixer. Mixers used for this purpose are tumble mixers, cone mixers, double-cone mixers, horizontal mixers, blenders and stirring units such as planetary mixers.

Normally, the formulation is processed in a heated extruder at temperatures, which are typically in the range from 70 to 120° C., preferably from 70 to 110° C., to obtain a melted mass of maximum homogeneity. Apparatus suitable for this includes single-screw cokneader, twin-screw extruders and planetary extruders. Addition is made in most cases by way of a screw conveyor, a conveyor belt or a shaking trough. Following extrusion, the hot mass is rolled out and cooled, for example on a cooling belt. When it has solidified, the mass is crushed and then ground. Suitable grinding units are pinned-disc mills, ultracentrifugal mills, jet mills and, especially, classifying mills. The powder may be subsequently classified and is preferably sieved. If desired, additional substances can be blended into the powder before sieving, for example anticaking agents such as silica or metal flake pigments.

The powder coating compositions of this invention have preferably a mean particle size of from 5 to 100 μm, and more preferably 30 to 50 μm.

Other techniques for the preparation of powder coatings (see EP-B-368 851 or WO-A-92/00342) have recently been disclosed, which can also be employed for this invention. In these techniques, the premixed formulation or extrudate is fed to a heated rotary tube and is spun out centrifugally on a rotating plate. At the edge of the plate, round, virtually monodisperse droplets are formed which solidify in cooled air before falling into a hopper.

A recent technique of preparing powder coating powders is described in EP-A-661 091 and WO-A-94/009913. All the components of the powder coating formulation are here mixed together in the presence of a super-critical liquid which is preferably carbon dioxide. The mixture is sprayed out of fine jets in such a way as to give rounded particles of powder paint of the required size when the carbon dioxide is flashed off.

Alternatively, the powder coating composition is prepared by any of the methods previously described by mixing and processing all of the components except for the coloured polymeric electrophotographic toner particles. The latter are then blended in an additional mixing step into the powder comprising the organic film-forming binder and optional further additives except for the coloured polymeric electro-photographic toner particles.

As a further alternative, the blending of the powder comprising the organic film-forming binder and optional further additives except for the coloured polymeric electrophotographic toner particles with said coloured particles can be done by simultaneously applying the two components to the substrate, for example by spraying from two different spray sources.

As a further alternative, the powder comprising the organic film-forming binder and optional further additives except for the coloured polymeric electrophotographic toner particles and said coloured particles can be applied separately to the substrate.

The following examples are further illustrating the present invention. Where not specifically mentioned, all percentages and parts are indicated in percent by weight or parts per weight.

### EXAMPLE 1

To prepare the aqueous phase, 73 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 8.1 g of UNISPERSE® Yellow B-PI (40% C.I. Pigment Yellow 13 preparation available from Ciba Specialty Chemicals) is then added to this polymer emulsion and emulsified for 5 minutes.

The oil phase is prepared by mixing 600 g ISOPAR G® (isoparaffin with a distillation range of 155-179° C. available from ExxonMobil Chemical) with 30 g AGEFLOC® WPT7593 (acrylic copolymer in hydrocarbon solvent available from Ciba Specialty Chemicals). The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 2

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 8.1 g of UNISPERSE® Yellow B-PI is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 3

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 9.13 g of UNISPERSE® Rubine 4BA-PA (35% C.I. Pigment Red 57:1 preparation available from Ciba Specialty Chemicals) is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 4

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 7.36 g of UNISPERSE® Blue G-PI (45% C.I. Pigment Blue 15:3 preparation available from Ciba Specialty Chemicals) is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 5

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 9.26 g of UNISPERSE® Black B-PI (35% C.I. Pigment Black 7 preparation available from Ciba Specialty Chemicals) is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 6

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 24.53 g of UNISPERSE® Blue G-PI is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 7

To prepare the aqueous phase, 100 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 30.87 g of UNISPERSE® Black B-PI is then added to this polymer emulsion and emulsified for 5 minutes.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 8

To prepare the aqueous phase, 73 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 8.1 g of UNISPERSE® Yellow B-PI is then added to this polymer emulsion and emulsified for 5 minutes. 3 g of ammonium zirconium carbonate are added and emulsified for a further minute.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 9

To prepare the aqueous phase, 73 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 9.13 g of UNISPERSE® Rubine 4BA-PA is then added to this polymer emulsion and emulsified for 5 minutes. 3 g of ammonium zirconium carbonate are added and emulsified for a further minute.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 10

To prepare the aqueous phase, 73 g of water and 200 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000) are stirred using a high speed mixer. 7.36 g of UNISPERSE® Blue G-PI is then added to this polymer emulsion and emulsified for 5 minutes. 3 g of ammonium zirconium carbonate are added and emulsified for a further minute.

The oil phase is prepared by mixing 600 g ISOPAR G® with 30 g AGEFLOC® WPT7593. The speed of the high shear mixer is reduced and the aqueous phase slowly added to the oil phase. Once the addition is complete, stirring is continued at high speed for 10 minutes to complete emulsification.

The water is removed by distillation at 45-50° C. under reduced pressure. The remaining oil is allowed to cool, and the coloured polymeric particles formed are isolated by filtration, washed with petroleum ether and allowed to dry at ambient temperature.

### EXAMPLE 11

To prepare the aqueous phase, 50 g of water and 100 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000), 0.49 g of the charge control agent DL-N24 and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

### EXAMPLE 12

To prepare the aqueous phase, 50 g of water and 100 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000), 0.49 g of the charge control agent DL-N22D and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

### EXAMPLE 13

To prepare the aqueous phase, 50 g of water and 100 g of an aqueous polymer microsuspension containing 32% of styrene-methyl methacrylate copolymer secondary particles (70:30 weight % monomer ratio, molecular weight 200,000) stabilised with a 14% styrene-acrylic acid copolymer (65:35 weight % monomer ratio, molecular weight 6000), 0.49 g of the charge control agent DL-P12 and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

### EXAMPLE 14

To prepare the aqueous phase, 50 g of water, 100 g of an aqueous emulsion, based on a styrene acrylic copolymer, 0.49 g of the charge control agent DL-P12 and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

### EXAMPLE 15

To prepare the aqueous phase, 50 g of water, 96 g of an aqueous microemulsion based on a carboxylated acrylic copolymer (68:32 weight % monomer ratio), 0.49 g of the charge control agent DL-N24 and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

### EXAMPLE 16

To prepare the aqueous phase, 50 g of water and 92 g of an aqueous emulsion containing styrene-methyl methacrylate copolymer secondary particles (98:2 weight % monomer ratio), 0.49 g of the charge control agent DL-N24 and 0.98 g of GLASSWAX® E1 are stirred using a high speed mixer. 2.45 g of IRGALITE Rubine LPBC is then added to this polymer emulsion and emulsified for 10 minutes.

The oil phase is prepared by mixing 300 g of ISOPAR G® with 15 g STABILISER® 1849. The speed of the high shear mixer is reduced and the aqueous phase slowly added to the oil phase. Once the addition is complete, stirring is continued at high speed for 20 minutes to complete emulsification.

The water is removed by distillation at 45-50° C. under reduced pressure. The remaining oil is allowed to cool, the coloured polymeric particles formed are isolated by filtration, washed with petroleum ether and allowed to dry at ambient temperature.

Charging properties: The charging properties and particle size distribution of the toners according to examples 11-16 are measured using a q/m meter (Epping-PES) and a Mastersizer X (Malvern), respectively. The results are as follows:

| | Example: | | | | | |
|---|---|---|---|---|---|---|
| | 11 | 12 | 13 | 14 | 15 | 16 |
| Charging (q/m) | −29.93 | −26.35 | −32.5 | 0.79 | −25.3 | 45.63 |
| [μC/g] | | | | | | |
| Average particle | 3.83 | 3.35 | 5.50 | 3.20 | 3.20 | 3.32 |
| size [μm] | | | | | | |

1. Coloured polymeric electrophotographic toner particles comprising
a polymeric matrix consisting of a copolymer (I) comprising reoccurring units derived from at least two monomers (a) and (b), wherein monomer (a) is an ethylenically unsaturated ionic or potentially ionic monomer and monomer (b) is an ethylenically unsaturated hydrophobic monomer,
which polymeric matrix is crosslinked or not crosslinked;
secondary particles of a hydrophobic polymer (II) distributed throughout said polymeric matrix, which hydrophobic polymer (II) comprises reoccurring units derived from an ethylenically unsaturated hydrophobic monomer (c) and optionally other monomers (d), and which hydrophobic polymer (II) is different from the copolymer (I) of the polymeric matrix;
a colourant; and
optionally a charge control agent.

2. Coloured polymeric electrophotographic toner particles according to claim 1, wherein monomer (a) is a salt of a counterion, which counterion is the conjugated acid of a volatile base or the conjugated base of a volatile acid.

3. Coloured polymeric electrophotographic toner particles according to claim 1, wherein the polymeric matrix comprises reoccurring units that are in free acid or free base form.

4. Coloured polymeric electrophotographic toner particles according to claim 1, wherein the copolymer (I) has a glass transition temperature of from 30 to 100° C.

5. Coloured polymeric electrophotographic toner particles according to claim 1, having an average particle diameter of from 0.1 to 20 μm.

6. Coloured polymeric electrophotographic toner particles according to claim 1, wherein the colourant is a pigment or a mixture of pigments selected from the group consisting of organic pigments and inorganic pigments.

7. Coloured polymeric electrophotographic toner particles according to claim 6, wherein the pigment is selected from the group consisting of monoazo, disazo, β-naphthol, naphthol AS, laked azo, benzimidazolone, azocondensation, metal complexes, azomethine, isoindolinone, isoindoline, phthalocyanine, quinacridone, perylene, perinone, indigo, thioindigo, anthraquinone, indanthrone, anthrapyrimidine, flavanthrone, pyranthrone, anthanthrone, dioxazine, triarylcarbonium, quinophthalone, diketopyrrolopyrrole, nitro, quinoline, isoviolanthrone, pteridine pigments, and mixtures thereof.

8. Coloured polymeric electrophotographic toner particles according to claim 1, further comprising an ingredient selected from the group consisting of waxes and UV absorbers.

9. Coloured polymeric electrophotographic toner particles according to claim 1, the fusing temperature of which is from 100 to 150° C.

10. A process for preparing coloured polymeric electrophotographic toner particles comprising
a polymeric matrix consisting of a copolymer (I) comprising reoccurring units derived from at least two monomers (a) and (b), wherein monomer (a) is an ethylenically unsaturated ionic or potentially ionic monomer and monomer (b) is an ethylenically unsaturated hydrophobic monomer,
which polymeric matrix is crosslinked or not crosslinked;
secondary particles of a hydrophobic polymer (II) distributed throughout said polymeric matrix, which hydrophobic polymer (II) comprises reoccurring units derived from an ethylenically unsaturated hydrophobic monomer (c) and optionally other monomers (d), and which hydrophobic polymer (II) is different from the copolymer (I) of the polymeric matrix,
a colourant and
optionally a charge control agent and/or further ingredients or a mixture of further ingredients,
which process comprises the steps of
(A) providing an aqueous phase comprising said copolymer (I);
(B) forming the secondary particles in said aqueous phase or preforming the secondary particles outside said aqueous phase and combining them with said aqueous phase;
(C) dissolving or dispersing the colourant and the optional charge control agent and/or further ingredients in the aqueous phase at any stage before, during or after steps (A) or (B);
(D) forming a water-in-oil emulsion consisting essentially of the aqueous phase from steps (A), (B), and (C), thus comprising the copolymer (I), the secondary particles, the colourant and the optional charge control agent and/or further ingredients, in a water immiscible liquid phase;
(E) removing water from said emulsion thereby forming an oil dispersion comprising solid coloured polymeric electrophotographic toner particles, the polymeric matrix of which comprises the secondary particles, the colourant and the optional charge control agent and/or further ingredients distributed throughout it; and
(F) optionally isolating, washing and/or drying said coloured polymeric electrophotographic toner particles.

11. An electrophotographic toner comprising coloured polymeric electrophotographic toner particles according to claim 1.

12. (canceled)

13. (canceled)

14. A two-component electrophotographic developer comprising the coloured polymeric electrophotographic toner particles according to claim 1.

15. A powder coating composition comprising a colouristically active amount of the coloured polymeric electrophotographic toner particles according to claim 1.

16. Coloured polymeric electrophotographic toner particles according to claim 1, wherein the colourant is present in an amount from 0.1% to 20% by weight, based on the weight of the coloured polymeric electrophotographic toner particles.

17. Coloured polymeric electrophotographic toner particles according to claim 4, wherein the copolymer (I) has a glass transition temperature of from 50 to 80° C.

18. Coloured polymeric electrophotographic toner particles according to claim 5 having an average particle diameter of from 0.8 to 9.9 μm.

19. Coloured polymeric electrophotographic toner particles according to claim 6, wherein the pigment or mixture of pigments is an organic pigment or a mixture of organic pigments.

20. A process for preparing coloured polymeric electrophotographic toner particles according to claim 10, wherein the colourant is present in an amount from 0.1% to 20% by weight, based on the weight of the coloured polymeric electrophotographic toner particles, the copolymer is in the form of a salt and the water immiscible liquid phase of step D comprises an amphipathic polymeric stabiliser.
